(19) United States
(12) Patent Application Publication
(10) Pub. No.: US 2014/0033986 A1
(43) Pub. Date: Feb. 6, 2014

(54) Play Device for Pets Enabling Dental Hygiene

(71) Applicant: John R. Hannan, Carmichael, CA (US)

(72) Inventor: John R. Hannan, Carmichael, CA (US)

(21) Appl. No.: 13/550,339

(22) Filed: Jul. 31, 2012

(51) Int. Cl. A01K 13/00

(52) U.S. Cl. 119/625; 119/600

(57) ABSTRACT

A play device for cleaning the teeth of pets during play, which may simulate a hand puppet. The play device may include a glove like body having at least two finger sleeves. The tips of the finger sleeves may bear removable brushing or scrubbing apparatus, such as bristles and flossing filaments. The glove like body may include the head of a mammal, disposed between the finger sleeves. The finger sleeves and brushing or scrubbing apparatus may include hook and loop fastener or other manually separable fasteners. The glove like body may be fabricated from a bite resistant material such as long chain synthetic aramid fiber.

### FIELD OF THE INVENTION

The present invention relates to oral hygiene for animals, and more particularly to a manual device adapted to encourage pets to allow their owners to conduct oral hygiene in a play setting.

### BACKGROUND OF THE INVENTION

Household pets have oral and dental care needs which are not addressed by their natural activities, and must be supplemented by human care givers. Notably, sound practice regarding dental and oral hygiene demands that pet owners find a way to brush, scrub, or otherwise clean tooth and gum surfaces of their pets to assure appropriate cleaning. Many pets are loath to have this performed, especially where the pet owner uses an implement such as a tooth brush which is involuntarily inserted into the pet's mouth. The animal may resist standard oral care by the owner.

Various products have been provided by the pet care industry to achieve natural brushing action or effect, such as by providing chewing toys comprising materials which are conducive to cleaning, such as leather, or other soft materials. These products may have localized effect, yet leave areas unaffected. Even when chewing vigorously, some tooth and gum surfaces will never experience scrubbing action. Obviously, spaces between teeth are notoriously resistant to scrubbing action or even to casual scraping as occurs with flossing when chewing on a chewing toy. Other mouth surfaces are equally in need of effective cleaning that cannot be provided by chewing toys.

There remains a need in the art for dental and oral implements which advance the state of dental and oral hygiene in pets.

### SUMMARY OF THE INVENTION

The present invention addresses the above stated need by providing a device which may come to be associated with play by pets, but which may be used for dental and oral care. In one implementation of the invention, such a device may take the form of a hand worn glove which bears cleaning apparatus such as small brushes, scrubbing surfaces, and flossing filaments incorporated therein. Such a device may be presented to a pet during the course of play fighting, so that the pet comes to welcome the activity. The pet owner may conduct cleaning once the device is in the mouth of the pet. In activities such as gentle play fighting, the animal may come to regard cleaning actions as part of the play.

In this way, a pet owner may be afforded access to the pet's mouth without encountering undue resistance by the pet, and may be able to clean the pet's mouth effectively without arousing antagonistic feelings on the part of the pet.

The hand worn glove may have replaceable cleaning elements, such as using hook and loop fastening material, or other manually separable fasteners. Also, a variety of cleaning elements may be substituted for one another to allow different forms of cleaning.

In one implementation of the invention, the hand worn glove may take on the appearance of a hand puppet.

It is an object of the invention to provide improved elements and arrangements thereof by apparatus for the purposes described which is inexpensive, dependable, and fully effective in accomplishing its intended purposes.

This and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is front view of one form of the invention.

FIG. 2 is a front view of a second form of the invention.

FIG. 3 is is a front view of a third form of the invention.

FIG. 4 is an enlarged perspective detail view of the right side of FIG. 3.

FIG. 5 is an enlarged cross sectional view of an alternative connector which could be utilized in place of the subject matter of FIG. 4.

### DETAILED DESCRIPTION

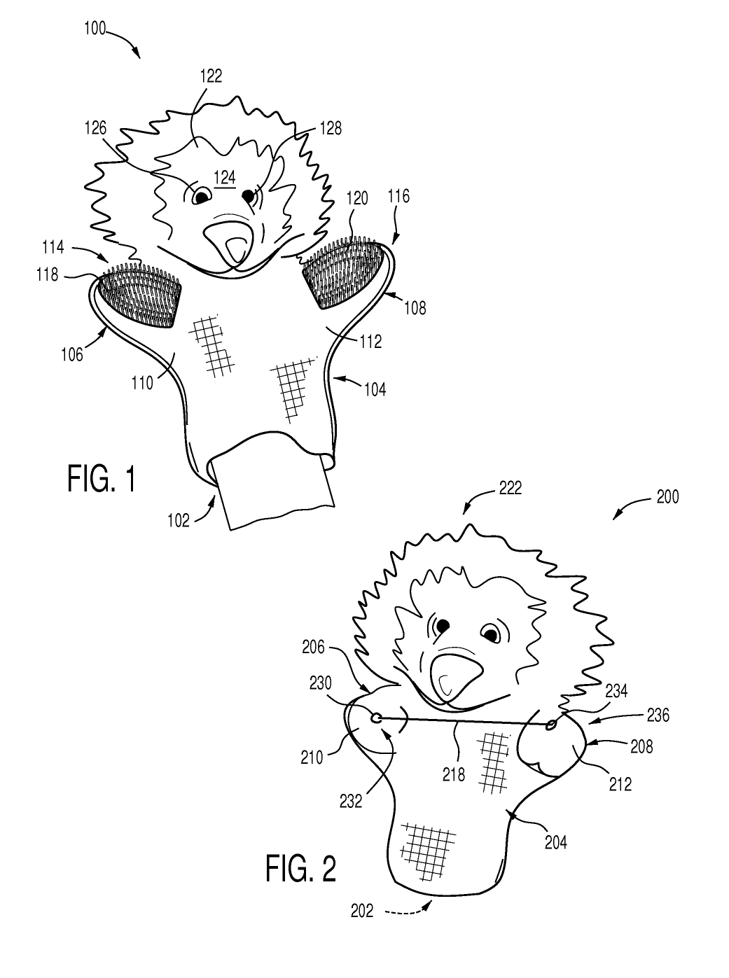

Referring first to FIG. 1, according to at least one aspect of the invention, there is shown a play play device 100 for enabling a user to scrub mouth surfaces of an animal (not shown). The play device 100 may simulate and share many structural characteristics of a hand puppet of the type used for amusement. To that end, the play device 100 may comprise a receptacle 102 for receiving the hand of the user (the arm 2 of the user is seen penetrating into the receptacle 102) in close cooperation therewith. The receptacle 102 may be defined within a main body 104 from which may project at least two finger sleeves 106, 108. Each finger sleeve 106 or 108 may be disposed to receive at least one finger of the user's hand therein.

Each one of the finger sleeves 106, 108 comprises a proximal end 110 or 112 which is joined to the main body 104, and a closed distal end 114 or 116. It will be appreciated that transition from that portion of the main body 104 which houses the palm of the hand to each one of the finger sleeves 106, 108 may be so gradual that no clear line of demarcation which would identify the proximal end 110 or 112 is clearly discernible. The concept of proximal ends 110, 112 is set forth herein merely to provide clear distinction for purposes of identifying closed ends 114, 116 of the finger sleeves 106, 108. A manually releasable fastening (to be described hereinafter) may be disposed at the closed distal end 114 or 116 of each one of the finger sleeves 106, 108.

It should also be understood that the term “finger sleeve” does not necessarily imply a member which receives only one finger. Rather, the number of fingers intended to be housed in a finger sleeve such as the finger sleeves 106 and 108 is at the discretion of the fabricator of the play device 100. It is merely necessary that the user be able to manipulate the play device 100 for the purposes describe herein.

A scrubbing element may be removably fastened at or near the closed distal ends 114, 116 of the finger sleeves 106, 108. A scrubbing element is apparatus which when rubbed against or scraped over teeth, gums, and other mouth surfaces of the animal will remove food particles and films, and other detritus from the mouth. In the example of FIG. 1, the scrubbing elements for each finger sleeve 106 or 108 comprise patches 118, 120 of brush bristles. Each patch 118 or 120 of brush bristles is removably fixed to the finger sleeves 106, 108 by a fastener which is complementary to and releasable from the manually releasable fastening of the finger sleeves 106, 108. the patches 118, 120 of brush bristles are thereby removable for cleaning, replacement, or other service.

The play device 100 may take the form of a hand puppet including a simulated animal head 122 connected to the main body 104. In the example of FIG. 1, the animal head 122 may simulate a mammal, and include distinctive facial features such as snout 124 and eyes 126, 128. To more realistically simulate an actual mammal, the simulated animal head 122 may be disposed between the finger sleeves 106, 108.

A pet may possibly respond to a simulation of an animal. Even if there is no recognition on the part of the pet of the simulated animal, simulation of an animal may assist in increasing consumer appeal in retail outlets.

FIG. 2 shows a play device 200 which is generally the structural and functional equivalent of the play device 100 of FIG. 1, with the exception that the scrubbing element comprises a flossing filament 218. The play device 200 may comprise a receptacle 202, a main body 204, and two finger sleeves 206, 208 having respective proximal ends 210, 212 and closed distal ends 214, 216 bearing manually releasable fastenings (to be described hereinafter). The components of the play device 200 listed above may be similar to their similarly named counterparts from the play device 100 of FIG. 1, and need not be further described.

The flossing filament 218 may have a proximal end 230 having a first complementing manually releasable fastening at the proximal end, such as a patch of hook and loop fastening material 232, and at the opposed distal end 234, a second manually releasable fastening at the distal end, such as another patch of hook and loop fastening material 236. The finger sleeves 206, 208 may be provided with permanently attached complementing patches of hook and loop material (not separately shown) which will enable the flossing filament 218 to be anchored at each finger sleeve 206, 208 and to be wielded with the flossing filament 218 held taut as depicted in FIG. 2. The flossing filament 218 may be manually removed from the play device 200, for renewal for example.

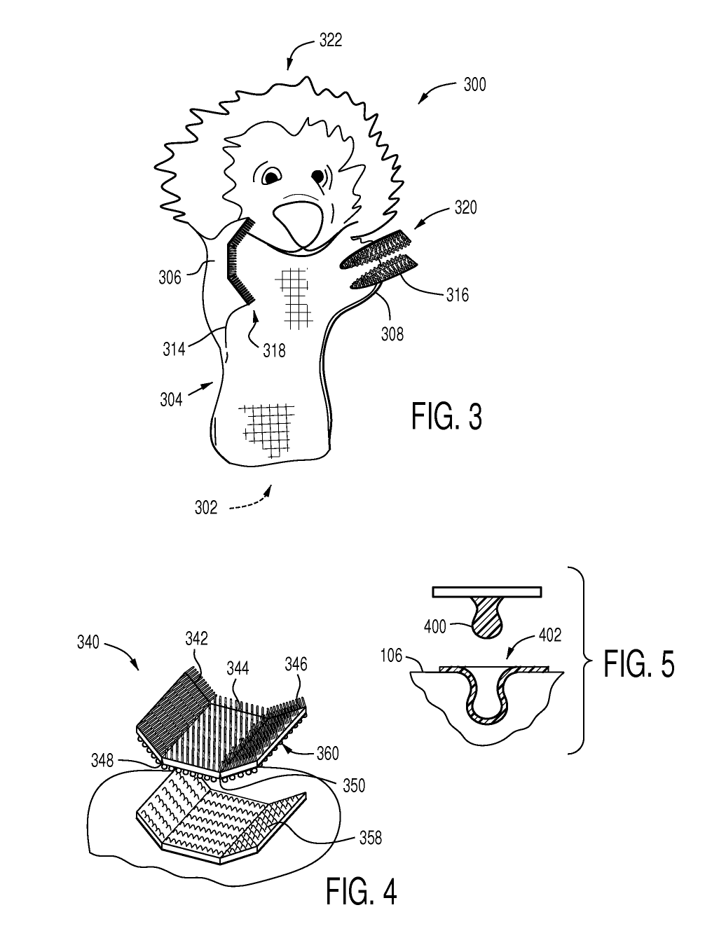

FIG. 3 shows a play device 300 which is generally the structural and functional equivalent of the play device 100 of FIG. 1, with the exception that the scrubbing element comprises assemblies 316, 318 of at least two form holding panels each abutting another form holding panel at a foldable joint. As depicted in FIG. 3 and as better seen in FIG. 4, the assembly may include three form holding panels 3, That portion of the scrubbing element which contacts the animal mouth in use may comprise any suitable brush material such as bristles, open cell foams, and the like.

The play device 300 may comprise a receptacle 302, a main body 304, and two finger sleeves 306, 308 having respective proximal ends (not called out by reference numeral, but similar to the similarly named components of the play device 100) and closed distal ends 314, 316 bearing manually releasable fastenings (to be described hereinafter). The play device 300 may simulate a hand puppet, having a head 322. The components of the play device 300 listed above may be similar to their similarly named counterparts from the play device 100 of FIG. 1, and need not be further described.

Referring particularly to FIG. 4, the scrubbing element of the play device 300 may comprise an assembly 340 of form holding panels comprising at least two form holding panels each abutting another form holding panel at a foldable joint, wherein the form holding panels comprise brush material. In the example of FIG. 4, the assembly 340 comprises three form holding panels 342, 344, 346 held together at foldable joints 348, 350, which may be live hinges for example. As employed herein, “form holding” signifies that the component so described is sufficiently rigid as to maintain its form in the absence of distorting forces, and will not slump or otherwise deform spontaneously. A bendable piece of elastomer which is sufficiently rigid as not to bend spontaneously would serve in this capacity, and is susceptible to being molded to include the live hinges seen as foldable joints 348 and 350.

It will be seen that the form holding panels 342, 344, 346 may seat against corresponding panels 352, 354, 356 which bear hook and loop material 358 which is complementary to the hook and loop material 360 fixed to the form holding panels 342, 344, 346. The corresponding panels 352, 354, 356 may be secured to the main body of the play device 300 that opposing panels 352 and 356 will be generally parallel to one another so that for example, an animal's tooth could be held between them and scoured.

FIG. 5 shows an alternative to hook and loop fastening material. An elastic male member 400 fixed to a scrubbing element such as patches 118, 120 of bristles may releasably mate with a resilient socket 402 fixed to the finger sleeve of a play device according to the present invention, such as the finger sleeve 106 of FIG. 1. Still other manually releasable fastening arrangements could be used if desired.

The body 104 and finger sleeves 106, 108 may be fabricated from a bite resistant constituent material, such as a material comprising a long chain synthetic polyamide fiber material. An example of such a commercially available material is known as Kevlar™, a product of DuPont™.

In use, a play object according to the invention such as the play device 100 may at first not be used for hygienic purposes. Instead, it may be used to protect the user's hand while engaging in play with a pet, for example, grasping the snout or other body parts by the hand protected by the play device. In time, in the course of play and after the animal has become accustomed to the play device, the user may massage, wipe, scour, scrape, or otherwise manipulate the teeth, gums, and other mouth surfaces of the animal to accomplish cleaning. With familiarity of the play device established with the animal, the animal will be less likely to find such manipulation objectionable, and due to its association with play, may come to welcome the activity.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A play device for enabling a user to scrub mouth surfaces of an animal, comprising:
a receptacle for receiving the hand of the user in close cooperation therewith, including a main body and at least two finger sleeves disposed to receive at least one finger in each of the two finger sleeves, wherein each one of the finger sleeves comprises a proximal end which is joined to the main body, and a closed distal end;
a manually releasable fastening disposed at the closed distal end of each one of the finger sleeves; and
a scrubbing element bearing a complementary manually releasable fastening which is matingly compatible with the manually releasable fastening of one of the finger sleeves.

2. The play device of claim 1, wherein the scrubbing element comprises brush bristles.

3. The play device of claim 1, wherein the scrubbing element comprises an assembly of form holding panels comprising at least two form holding panels each abutting another form holding panel at a foldable joint, wherein the form holding panels comprise brush material.

4. The play device of claim 1, wherein the scrubbing element comprises a flossing filament including a proximal end, a distal end, a first manually releasable fastening at the proximal end, and a second manually releasable fastening at the distal end.

5. The play device of claim 1, wherein the play device comprises a hand puppet having a simulated animate head connected to the main body.

6. The play device of claim 5, wherein the simulated animate head simulates a mammal.

7. The play device of claim 5, wherein the simulated animate head is disposed between the finger sleeves.

8. The play device of claim 1, wherein the manually releasable fastening disposed at the closed distal end of each one of the finger sleeves and the complementary manually releasable fastening of the scrubbing element comprise complementary patches of hook and loop fastener.

9. The play device of claim 1, wherein the receptacle comprises a bite resistant constituent material.

10. The play device of claim 9, wherein the bite resistant constituent material comprises a long chain synthetic polyamide fiber material.
